(19) United States
(12) Patent Application Publication
(10) Pub. No.: US 2022/0044017 A1
(43) Pub. Date: Feb. 10, 2022

(54) H.V.E.

(71) Applicants: Hendrix Thomas Dyke, Rawhay, NJ (US); Shakira Nida Hogan, Rawhay, NJ (US)

(72) Inventors: Hendrix Thomas Dyke, Rawhay, NJ (US); Shakira Nida Hogan, Rawhay, NJ (US)

(21) Appl. No.: 17/346,263

(22) Filed: Jun. 13, 2021

Related U.S. Application Data
(60) Provisional application No. 63/042,492, filed on Jun. 22, 2020.

(51) Int. Cl. G06K 9/00; G06F 16/435; G06F 16/41

(52) U.S. Cl. CPC G06K 9/00671; G06F 16/41; G06F 16/435

(57) ABSTRACT

The present invention illustrates a story book virtual reality application that includes, but is not limited to scanning capability, 3D graphics presentation and video presentation that immerses participants into experiencing the story line of a story book though mobile virtual reality viewing devices or cast onto to television via app. The book cover or a page in the book itself can be scanned with a smart device (smart phone, tablet, Kindle, Nuke, MAC, PC, laptop), which activates the virtual reality book application to get the appropriate content of the VR-Book. The participant can then experience themselves being fully immersed into experiencing the story line through their virtual reality viewing device, when displaying the video VR content using the VR application, through their mobile phone or cast to television via app. Therefore, the invention allows participants to be immersed into the story book as real time spectating participant in the story book using pre filmed real life actors and participants who represent the selected character or characters in the story book.

### CROSS-REFERENCE TO RELATED APPLICATIONS

This application claims the benefit of priority under 35 U.S.C. § 119(e) to U.S. provisional application No. 63/042,492 filed Jun. 22, 2020. Each of the aforementioned applications is incorporated herein by reference in its entirety.

### BACKGROUND

Books are literally one of the oldest media for providing an entertainment experience. Recently, book technology has taken a quantum leap forward with the development of e-books, both with dedicated devices as well as with applications such as Amazon's Kindle®, but the same simply replace a paper page with an electronic page, although some provide ancillary functionality such as dictionaries or the ability to take notes. Audio books are also well known, in which an audio file constituting a read-back book text is rendered for a user, such as for consumption during driving, exercising, running, walking, or the like.

Other attempts at advancing the technology of books have been made, and the development of touchscreen computing has made such efforts ubiquitous. Examples include interactive books, books that “read” themselves audibly as a child touches words or sentences, books in which a reader can choose an ending, and the like.

Still, reading tends to be a solitary experience, and from a technical perspective non-immersive.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

The present invention, VR-Book, is the embodiment of an virtual reality book application that immerses participants (readers of the book), while viewing an actual physical story book, picture book or viewing a story book via the VR application. The stories come alive in the form of 360 videos that are pre-recorded creating an illusion of stories becoming alive through the performances of the actors, participants when viewed through the mobile application. With this method, the subject virtually immersed in the story much like a story line character. The participant is able to watch the elements of the story some to life in a virtual world that fully immerses the participant into the story.

The present invention has different control mean: (a) a scanner to scan a graphics pattern to activate and use the story book application, using commercially available devices (smart phone, tablet, PC, laptop); (b) an electronic mobile device to use a commercial smart device (smart phone, tablet, PC, laptop) access the application; (c) a mobile VR headset to generate the VR experience, and video that immerses one or more participants into the VR story book experience. (d) a television to optionally access the video though casting methods to optionally display the VR experience and the video in a user-friendly way to the participant storybook and mobile phone.

Therefore, the present VR-Book virtual reality application invention can be used on commercial smart devices (smart phone, tablet, Kindle, Nuke, MAC, PC, laptop) and for 3D graphics and video. The present application provides an advantage to handle different languages. When the user activates the video mode, it is supported by audio to play in real-time.

These features, and other features and advantages of the present invention will become more apparent to those of ordinary skill in the relevant art when the following detailed description of the preferred embodiments is read in conjunction with the appended drawings in which like reference numerals represent like components throughout the several view

### BRIEF DESCRIPTION OF THE DRAWINGS

FIG. 1 (a and b) shows a perspective view of the story book, either actual or within a website.

FIG. 2 (a and b) shows a first perspective view of the VR-Book application to welcome a visitor.

FIG. 3 shows a third perspective view of the VR-Book application where the VR-Book application displays the text to ask the user to open the book and point the device to the graphics pattern to access the corresponding video to VR story book.

FIG. 4 shows a fourth perspective view of the VR-Book application for the user to select the desired video selections viewing options.

FIG. 5 shows a fifth perspective view of the VR-Book application, which facilitates the user to select the desired 360 viewing method with mobile viewers.

FIG. 6 (a and b) shows a sixth perspective view of the VR-Book application wherein the participant's loads the mobile electronic device into the portable 360 viewers to access the VR video.

FIG. 7 shows a seventh perspective view of the VR-Book application where the user is instructed to place the VR goggles complete with affixed electronic mobile device to head.

FIG. 8 shows an eighth perspective view of the VR-Book application being viewed in its capacity. The VR-Book application is activated and viewed through the scanned graphics pattern on the story book page, through the VR goggles that allows the viewer to immerse into the 360 VR video which corresponds with the VR story book.

### DETAILED DESCRIPTION OF PREFERRED EMBODIMENTS

The present invention immerses readers into the story line of a story book by virtually transporting them as a physical spectator in the picture book for a total immersion experience. The book could be papers combined or in the form of a paper or a simple card with words in it. When the user reads the book, he/she scans the page, graphics pattern, through the application. This is viewed in a 360 video in a device where a short 360 video of the story is performing a scene of the story line.

The present invention has (a) a scanner to scan a graphics pattern to activate and use the story book application, using commercially available devices (Smartphone, tab let, PC, laptop); (b) a user input control means to use a device (Smartphone, tablet, PC, laptop), to view the video that interacts with the VR-Book application; (c) a computer coupled to the scanner and responsive to the user input control means and operatively programmed to generate 360 videos that immerses participants into the story book story line; and (d) an interface controlled by the computer and arranged to display the video and/or graphics in response to the participants story book and the computer.

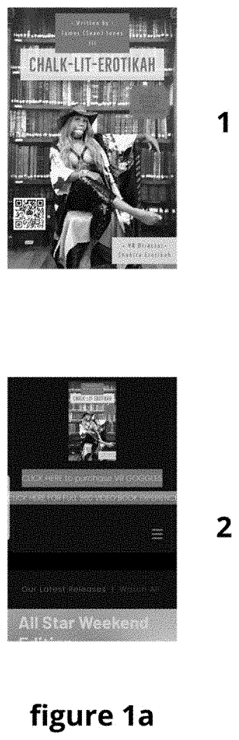

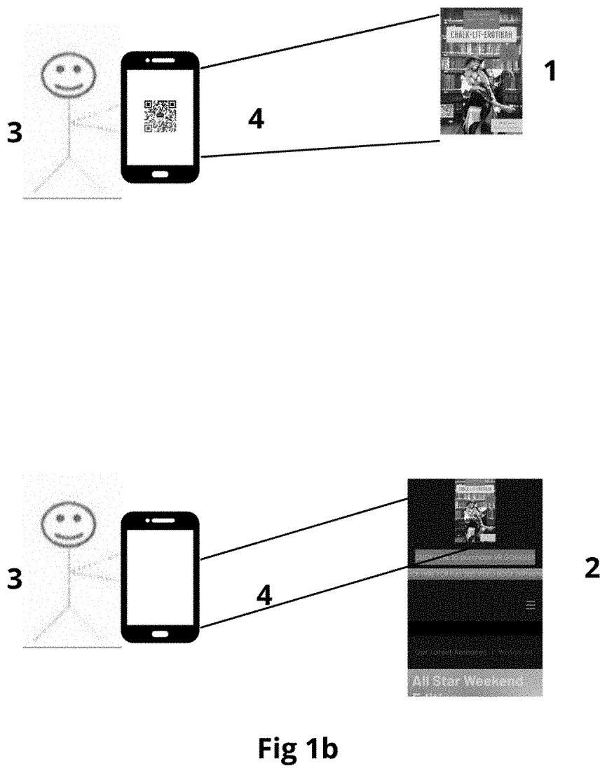

FIG. 1a shows a perspective view of the story book, which is either actual 1 or within a website 2. The book can also be a simple card printed or an artwork or a photograph on any print material 1. The Smart device scans 4 the book 1 or the representative website book 2 to activate the VR-Book application.

As seen in FIG. 1b the user 3 of the device readies the device to the picture mode to readily scan 4 the graphics pattern in the story book 1, 2 to activate the VR-Book application and uses the VR-Book application scan process to activate the 360 video relative to the story book.

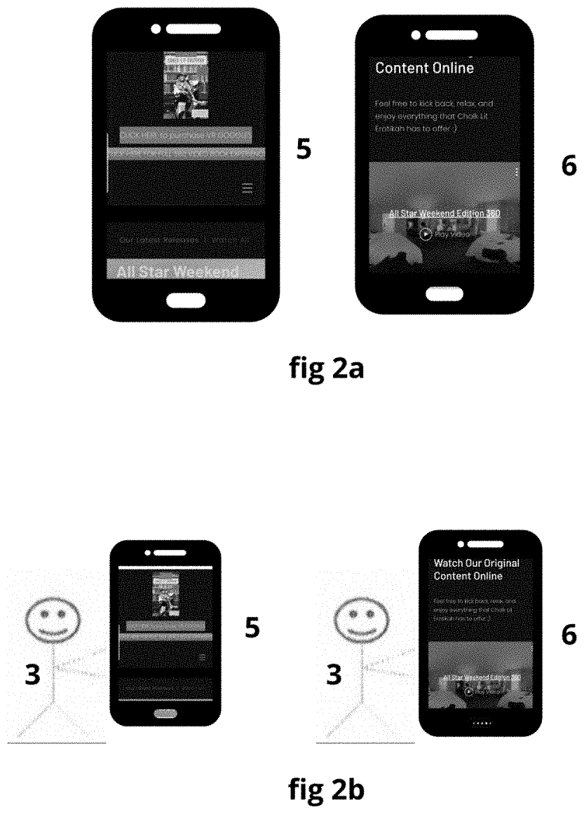

FIG. 2(a and b) shows another perspective view of the VR-Book application welcoming a user 3. It shows Screen examples for smart-phone 5 or tablet 6.

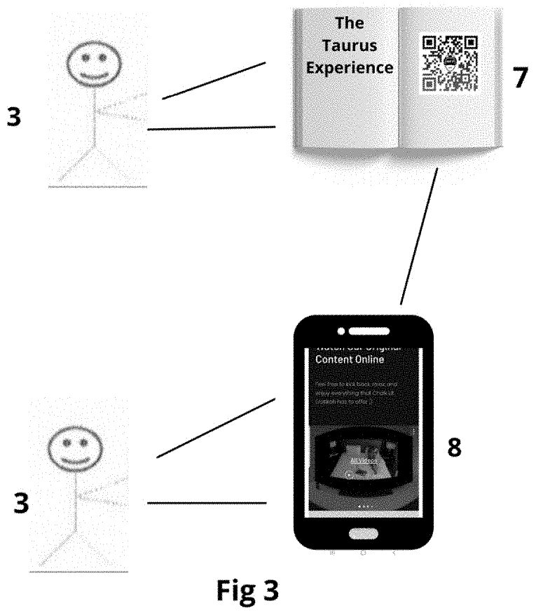

FIG. 3 shows a third perspective view of the VR-Book application where the VR-Book application displays the text to ask the user to open the book 7 and point the device to the graphics pattern to access the corresponding video to VR story book 8.

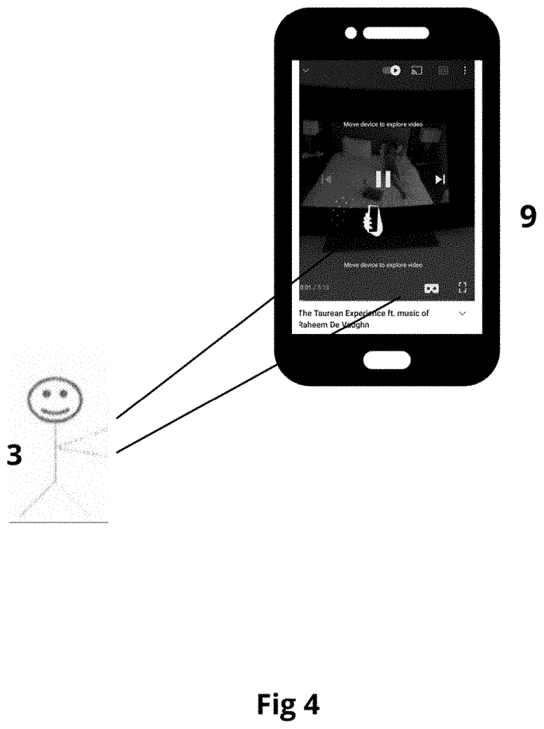

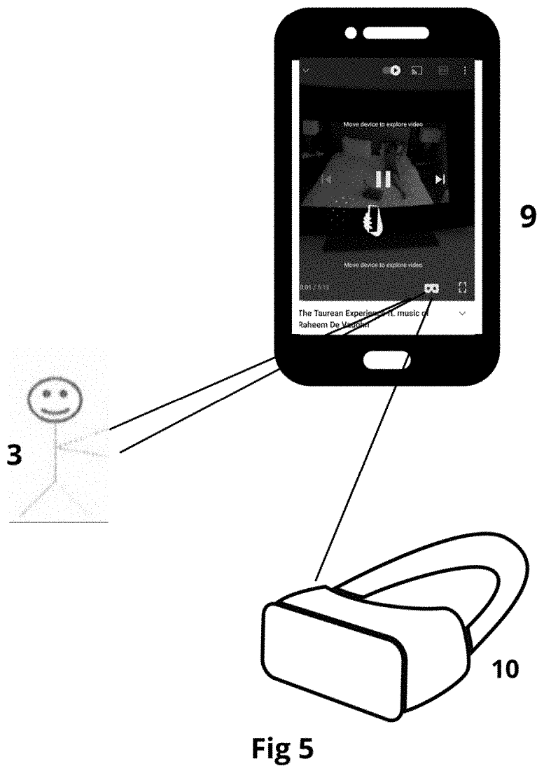

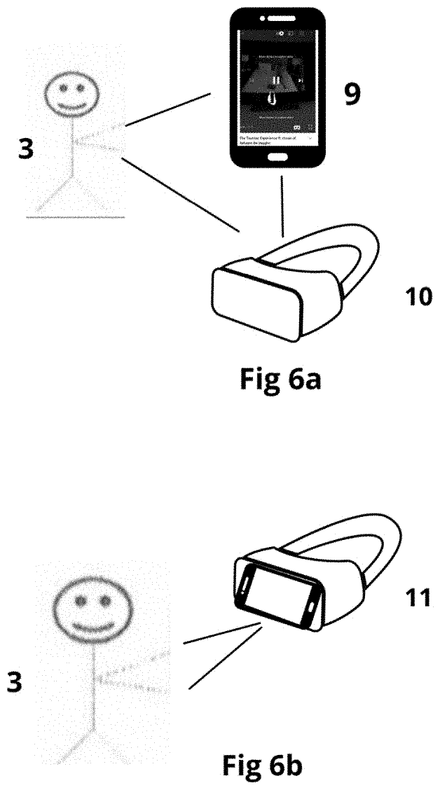

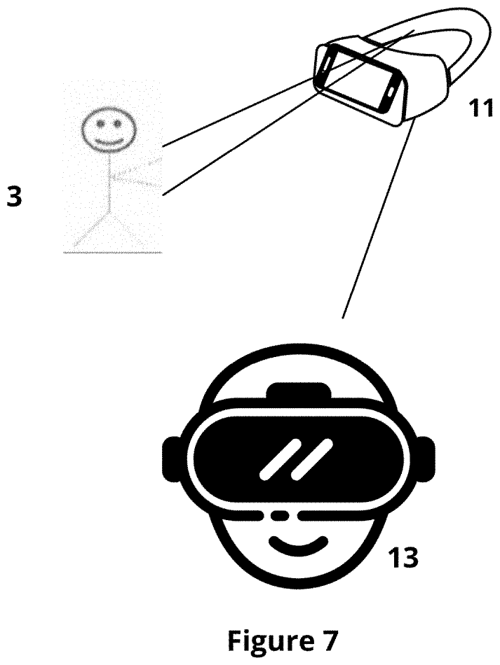

FIG. 4 shows a fourth perspective view of the VR-Book application for the user to select the desired video selections viewing options, activating a 360 video 9, based on each story's content. The VR-Book application activates video based on each story's content, from the first page until the last page, for total immersion into the story line. When the user activates the video mode, it is Supported by an audio to play in real-time and the user interactions a total virtual immersion into the storyline though 360 video.

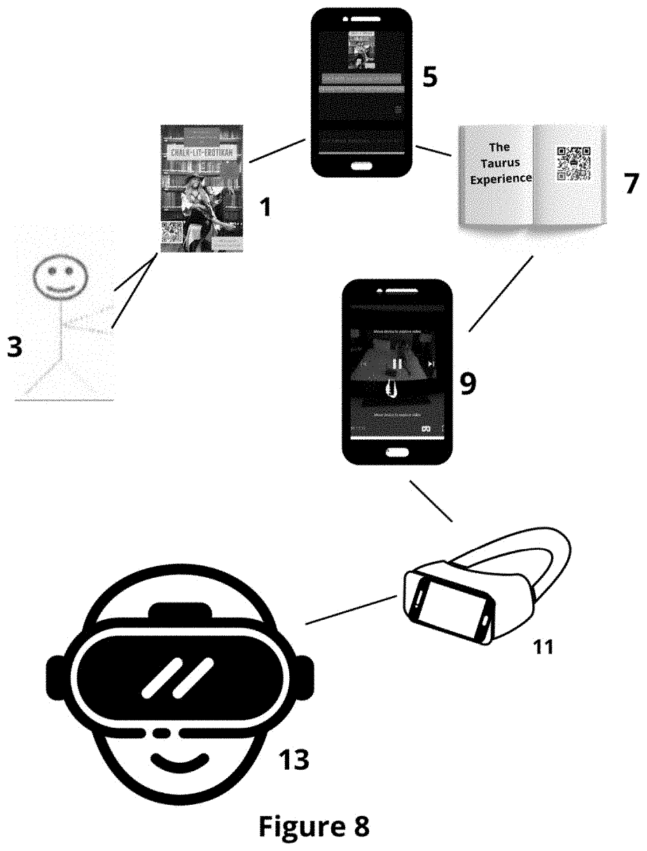

FIG. 8 describes the summary of the invention in a schematic format. The user is asked if he/she is using a Chalk lit Erotikah VR book 1, or Chalk lit Erotikah VR book website 2. If yes, the VR book is scanned using a scan-able device 4. The VR book real or the web presence is scanned 4. Finally, the VR book experience in 360 video form is activated 7.

The VR-Book augmented reality application invention also can include prior art and technology that is available on commercial Smart devices (Smart phone, tablet, Kindle, Nuke, MAC, PC, laptop). The invention also can include art and technology used for 3D graphics and video

In future embodiments, we envision the user being able to incorporate the following features:

Add more coded story books to expand use of the invention;
Continuously improve the vibrancy of the videos, graphics and avatars;
Expand the number of available videos from which to choose;
Incorporate options for google, YouTube, Facebook and similar glasses technology; and
Expand for Hologram technology.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

That which is claimed:

1. A story book virtual reality (VR) application to immerse one or more participants into a story line while viewing an actual physical VR-Book, a story book, a story book via VR application wherein one or more stories come alive in the form of a video, having been pre-recorded in 360 video content with real life actors or participants. The participant becomes a part of the story VR Experience along with the one or more story line characters while displaying the VR content, having (a) a scanner, (b) an mobile device, (c) a mobile VR headset, and (d) an television, wherein:
a) the scanner scans a graphics pattern using at least one smart device to activate and use the story book application;
b) the mobile device uses the at least one smart device to access the 360 video to, interact with the VR-Book application;
c) the mobile VR headset, generates the VR experience and a video that immerses one or more participants into the VR story book story experience; and
d) the television displays the VR experience and the video in a user friendly response to the participant story book and the mobile phone.

2. The story book virtual reality application to immerse one or more participants into the story line of claim 1, wherein the story book comprises an actual story book (1) and a website story book (2) and a user (3) alerts the at least one smart device to the video mode to readily scan (4) a cover of the actual picture book (1), the website story book (2) to activate the VR-Book application.

3. The story book virtual reality application to immerse one or more participants into the story line of claim 1, wherein the smart device includes a smart-phone (5) and a tablet (6).

4. The story book virtual reality application to immerse one or more participants into the story line of claim 1, wherein a welcome screen is displayed on the smart device and asks the user (3) to enter (9) contact email text for the participant such that the user (3) enters the contact email text of each participant (10), which is saved by an VR-Book application database (12).

5. The story book virtual reality application to immerse one or more participants into the story line of claim 4, wherein the user (3) selects corresponding video to selected storybook.

6. The story book virtual reality application to immerse one or more participants into the story line of claim 4, wherein a 360 video (14) is displayed by the VR-Book application database (12) and asks the user (3) set up the portable VR viewers with mobile device to access VR video.

7. The story book virtual reality virtual to immerse one or more participants into the story line of claim 5, wherein the user (3) clicks a video play button to activate and play story book video that is saved into the VR-Book application database.

8. The story book virtual reality application to immerse one or more participants into the story line of claim 4, wherein the user (3) selects the corresponding VR video from display of one or more VR videos (17) that has been previously selected and saved by the VR-Book application database (12) and selects an desired corresponding VR video (22).

9. The story book virtual reality application to immerse one or more participants into the story line of claim 1, wherein the participant's mobile device (16) and the mobile 360 viewers (17) is attached to to the user (3).

10. The story book virtual reality application to immerse one or more participants into the story line of claim 1, wherein the user (3) opens a book, reads the book, (30, 31) and scans the graphics pattern to access 360 video clips at leisure (32).

11. The story book virtual reality application to immerse one or more participants into the story line of claim 13, wherein a 360 video, (35) can be activated by scanning the graphics pattern within the story book, to access corresponding 360 video to be displayed and viewed with mobile VR headset, VR and electronic mobile device for total VR immersion into the story line.

12. The story book virtual reality application to immerse one or more participants into the story line of claim 1, wherein the video is supported by an audio to play in real-time.

13. The story book virtual reality application to immerse one or more participants into the story line of claim 1, wherein the user handles the VR book in one or more languages.

17. The story book virtual reality application to immerse one or more participants into the story line of claim 1, wherein the application works with mobile VR television casting technology and methods.

18. The story book virtual reality application to immerse one or more participants into the story line of claim 1, wherein the application works with all electronic mobile viewing devices including google, YouTube, Facebook, and similar glasses.

19. A virtual reality (VR) application to immerse one or more participants into a story line while the story comes alive in the form of a 360 video. The participant becomes part of the story virtually along with the one or more story line characters while immersed in the VR content, having (a) a scanner, (b) an mobile device, (c) a mobile VR headset, and (d) a television, wherein:
a) the scanner scans a graphics pattern using at least one smart device to activate and use the application;
b) he mobile device uses the at least one smart device to access the 360 videos and to interact with the VR book application;
c) the mobile VR headset generates the VR experience and a video that immerses one or more participants into the story line; and
d) the television displays the VR experience and the video in a user-friendly response to the participant, storybook, and electronic mobile device.
